(19) United States
(12) Patent Application Publication
(10) Pub. No.: US 2023/0202152 A1
(43) Pub. Date: Jun. 29, 2023

(54) MULTI-LAYER STRUCTURE FOR THE REALIZATION OF A FLOOR COVERING WITH ACOUSTIC INSULATION PROPERTIES

(71) Applicant: GERFLOR, VILLEURBANNE (FR)

(72) Inventors: Nicolas CHABAN, Saint Restitut (FR); Theo VIALON, Saint-Paul-Trois-Châteaux (FR)

(21) Appl. No.: 18/146,098

(22) Filed: Dec. 23, 2022

(30) Foreign Application Priority Data
Dec. 29, 2021 (FR) 2114643

(51) Int. Cl. B32B 27/06; B32B 27/30; B32B 27/08; B32B 5/18; B32B 7/02; B32B 5/02; B32B 27/12

(52) U.S. Cl. CPC B32B 27/065; B32B 27/304; B32B 27/08; B32B 5/18; B32B 7/02; B32B 5/022; B32B 27/12; B32B 2419/04; B32B 2307/102; B32B 2307/54; B32B 2266/0235; B32B 2307/732; B32B 2307/72; B32B 2262/101; B32B 2307/554; B32B 2307/546; B32B 2266/08; B32B 2307/412

(57) ABSTRACT

A multi-layer structure of the tile or slat type is for the realization of a floor covering having acoustic insulation properties. The structure includes, in this order, a decorative layer, a first rigid layer made of PVC, a first damping layer made of PVC, and a second rigid layer made of PVC. The first and second rigid layers each have an elasticity modulus of between 1.5 GPa and 12 GPa, measured according to standard ISO 178:2011.

### CROSS-REFERENCE TO RELATED APPLICATION

This application claims priority to French Patent Application No. 2114643 filed on Dec. 29, 2021, the disclosure of which including the specification, the drawings, and the claims is hereby incorporated by reference in its entirety

### TECHNICAL FIELD

The present invention relates to the field of floor coverings, and relates more specifically to a multi-layer structure, for example in the form of a tile or a slat, for the realization of a floor covering with acoustic insulation properties.

By acoustic insulation properties, this means the attenuation of the impact noise and comfort when walking measured, for example, according to NF EN ISO 717-2.

### PRIOR ART

Document WO2018162828 is known from the prior art, which describes a multi-layer panel for the realization of a floor covering having acoustic insulation properties, at least one of the layers of which is made of PVC and comprising at least one decorative layer bonded to a backing layer.

According to this document, the backing layer is bonded to a non-woven textile sublayer, intended to be in contact with the floor, and having a thickness of between 0.5 mm and 3 mm.

This document makes it possible to improve the acoustic insulation performance of a floor covering, in particular the attenuation of impact noises, according to standard EN ISO 10140-3.

However, the attenuation of the impact noise and the acoustics when walking can also be improved to satisfy the standard NF EN ISO 717-2.

### SUMMARY OF THE INVENTION

One of the aims of the invention is therefore to improve the multi-layer structures of the prior art to satisfy the standard NF EN ISO 717-2 providing conditions for attenuating the impact noise and sound when walking, while keeping a satisfactory punching resistance according to standard NF EN ISO 24343-1. The invention in particular aims to improve the acoustic attenuation according to standard NF S31-074-717-2 and NF EN ISO 717-2, in particular to reach an acoustic attenuation of 6 dB, even 17 dB, ideally 19 dB, and to improve the sound when walking according to NF EN ISO 10140-3 and NF EN ISO 717-2, in particular to reach a sound when walking value of less than or equal to 80 dB.

To this end, the multi-layer structure according to the invention comprises, in this order, a decorative layer, a first rigid layer made of PVC, a first damping layer made of PVC, a second rigid layer made of PVC, with the first and second rigid layers each comprising an elasticity modulus of between 1.5 GPa and 12 GPa, measured according to standard ISO 178:2011.

In this way, the presence of two rigid layers, combined with a damping layer makes it possible to obtain a multi-layer structure having a rigid aspect for the user, i.e. qualitative, while having good impact noise attenuation properties and a good comfort when walking according to standard NF EN ISO 717-2, and which avoids phenomena of transferring irregularities from the support onto the surface of the decorative layer.

The decorative layer is preferably made of PVC such that the multi-layer structure has a good recyclability, as made mainly of PVC, with optionally a non-detrimental quantity of glass fibers.

The multi-layer structure also has a good thermal and dimensional stability, in particular according to the criteria retained in standard NF EN ISO 23999:2018. Indeed, the presence of two rigid layers makes it possible, when this type of covering is subjected to high temperature variations, in particular when it is placed behind bay windows, to limit shrinkage and expansion phenomena. These phenomena lead to the appearance of defects, known as “doming” (the panels curve and become unstuck locally from the floor by forming a hump), unclipping from the means for assembling panels or also the appearance of gaps between two consecutive panels. The placing of the multi-layer structure is also facilitated by the presence of the two rigid layers which provide a satisfactory handling rigidity to the covering. As an illustration, this rigidity is sufficient such that in the case where an end of the multi-layer structure is held by leaving the other free end, for example, on the edge of a table, the structure does not directly lower from the point where it is no longer held, but progressively over the whole length of the structure.

Preferably, the multi-layer structure comprises a thickness of between 4 and 8 mm, with the first rigid layer having a thickness of between 1 and 3.5 mm, and the second rigid layer having a thickness of between 1 and 3 mm. The first damping layer preferably has a thickness of between 0.3 and 2 mm.

A greater thickness of the first and second rigid layers would degrade the acoustic attenuation and the acoustics when walking, while a lesser thickness would degrade the punching resistance.

With the thickness of the multi-layer structure being limited, the modification of the thickness of one of the rigid layers has the consequence of modifying the thickness of the other. For example, a first, 3 mm thick rigid layer and a second 2 mm thick rigid layer is a possible example of thickness combinations.

Preferably, the first damping layer made of PVC can be a non-foam layer made of PVC. Preferably, the first non-foam damping layer comprises a Young's modulus between 25 MPa and 1.5 GPa, and preferably between 50 MPa and 500 MPa. Preferably, the first non-foam damping layer comprises a thickness of between 0.4 and 1 mm, more preferably between 0.6 and 0.8 mm. This can, in particular, be made by calendering, pressing or also extrusion.

The first non-foam damping layer has, for example, a density of between 1200 and 2200 kg/m³. This layer can, in particular, be made by calendering, extrusion, pressing or coating. This first non-foam damping layer enables, in particular, the multi-layer structure to comprise male/female assembly means made at least partially in the thickness of the first damping layer. Advantageously, the male/female assembly means are made at least partially in the thickness of the first damping layer and in the thickness of the first rigid layer and/or of the second rigid layer.

The first damping layer made of PVC can be a non-foam layer made of PVC having a tensile strength of between 4 and 21 DaN/cm.

It is well-known that in the case of PVC, the filler and/or plasticizer and/or shock absorber amount, as well as the grade of the PVC used in the composition of the layer makes it possible to make its performance vary when extending and flexing. These parameters can easily be adapted to meet the expected mechanical features.

As an example, the first damping layer, when it is made of PVC and non-foam, can in particular be made of a plasticized and expanded polyvinyl chloride. Said composition can in particular comprise a quantity of plasticizer of between 40 and 50 PCR (percentage share of resin). Said composition can in particular comprise a quantity of mineral fillers of between 80 and 200 PCR. Mineral fillers could be used according to the invention are, for example, clays, silica, kaolin, talc, chalk, lime, calcium carbonate, individually or combined.

Alternatively, the first damping layer made of PVC can be a foam layer made of PVC. Preferably, the first foam damping layer comprises a storage modulus of between 0.1 MPa and 10 MPa. This layer can, in particular, be made by coating from a composition comprising an expanding agent, such as azodicarbonamide or by extrusion. According to this alternative, male/female assembly means can be made in the thickness of the first rigid layer and/or in the thickness of the second rigid layer.

The male/female means for bonding or assembling two multi-layer structures according to the invention are in particular described in documents GB 2 256 023, EP 1 026 341, WO 2012/004701, EP 2 843 153 or also WO 2016/030627.

Preferably, the first rigid layer and/or the second rigid layer comprise a density of between 1150 kg/m³ and 2500 kg/m³, preferably between 1600 kg/m³ and 2100 kg/m³.

A lower density would degrade the punching resistance and the rigidity of the structure, while a greater density would degrade the attenuation of impact noises and noises when walking.

Preferably, the multi-layer structure comprises a second damping layer intended to be in contact with the floor and made of PVC foam or in the form of a non-woven glass fiber sheet. The second damping layer preferably has a thickness of between 0.5 and 1.5 mm.

In this way, the presence of two rigid layers, combined with the two damping layers makes it possible to obtain a multi-layer structure having a rigid aspect for the user, i.e. qualitative, while having very good impact noise attenuation properties and a very good comfort when walking, according to standard NF EN ISO 717-2, and which avoids the phenomena of transferring irregularities from the support onto the surface of the decorative layer.

The first damping layer, when it is made of PVC foam and/or the second damping layer of PVC foam each comprise a density of between 150 and 600 kg/m³, preferably between 300 and 450 kg/m³, for a thickness of between 0.5 and 1.5 mm, preferably between 0.8 and 1.2 mm, and more preferably between 0.9 and 1.1 mm. The use of foam in PVC favors the recycling of all of the multi-layer structure. On the other hand, this also makes it possible to facilitate the assembly of the multi-layer structure, the different layers being directly compatible with one another and can optionally be assembled by thermo-lamination.

A lower thickness of the first damping layer and/or the second damping layer would degrade the acoustic attenuation and the acoustics when walking, while a greater thickness would degrade the punching resistance. A lower density decreases the storage modulus, while a greater density will tend to increase it. The storage modulus comprises in particular mechanical energy stored by the material during a filling cycle. Consequently, the storage modulus is linked to the rigidity and to the recovery of the shape of the material during filling.

As an example, the storage modulus of the first PVC foam damping layer and/or of the second PVC foam damping layer is between 0.1 MPa and 10 MPa, preferably between 0.3 and 1 MPa, more preferably between 0.4 and 0.5 MPa, measured according to a test method based on standard EN 29052-1: 1992.

The complex Young's modulus of a material is constituted of two components: the storage modulus E′ and the loss modulus E″. The storage modulus represents the elastic performance of a material. It is the capacity of the material to store energy to fully return it in the form of deformation. Conversely, the loss modulus E″ represents the viscous part of the material (energy dissipated in heat and not returned).

The determination of the resonant frequency (rf) of the mass/spring/mass system makes it possible to obtain the apparent dynamic stiffness per surface unit sₜ′ of the test piece according to the equation

$$r f = \frac{1}{2 π} * \sqrt{\frac{{s}_{t}^{′}}{{m}_{t}^{′}}}$$

with: mₜ′ the total mass per surface unit used during the test.

The measuring device used is constituted of a system which manages a so-called “white noise” excitation signal, amplified by a power amplifier before being transmitted to a vibrating pot. An impedance head makes it possible to recover the injected force, as well as the movement speed of the mass/spring/mass system.

These signals are then amplified by load amplifiers before being transmitted to the system to be processed and analyzed.

The experimental device therefore consists of using a mass of 250 kg placed on marble, a surface sample of 20 cm×20 cm and a plate of 4 or 8 kg on the sample. The measurement is taken as follows:

Excitation by vibrating pot of a white noise to the normal of the device on the plate in the frequency range of the first resonance.

Measurements of the response from the system in the place of the excitation on the impact and recovery of the FRF (fundamental resonant frequency).

Analysis of the damping (method at −3 dB on the FRF) as well as the first resonant frequency of the sample.

The calculation of the dynamic stiffness by surface unit s′, in MN/m³ is broken down as follows:

s′=sₜ′+sₐ′, with: sₜ′: apparent dynamic stiffness by surface unit of the test piece, in MN/m³

sₜ′=4π²·mₜ·rf²

where:

mₜ is the surface mass of the load applied on the test piece in kg/m²,

rf is the resonant frequency in Hz of the Mass/Spring/Mass system,

sₐ′ is the dynamic stiffness by surface unit of the captive gas (in this case, air), in MN/m³ with sₐ′=P₀·/dₜ·ε,

P₀ is the atmospheric pressure, in Mpa,

dₜ is the thickness of the porous part of the test piece under the static load applied, in mm,

ε is the porosity of the material with ε=1— (m/p·dt),

M is the surface mass of the material of the test piece, in kg/m²,

ρ is the bulk density of the solid constituent of the material of the test piece, in kg/m³.

The calculation of the storage modulus (E′) from these values is performed according to the following method:

E′=s′·dₜ

with E′ in MPa, s′ in MN/m³ and dt in meters.

Preferably, the first damping layer and/or the second damping layer are made of closed cell PVC foam, in order to improve the acoustic attenuation and decrease sound when walking.

When the second damping layer is presented in the form of a non-woven glass fiber sheet, this preferably has a thickness of between 0.7 and 1.7 mm, preferably between 1 and 1.5 mm, more preferably of 1.4 mm.

A lower thickness would degrade the acoustic attenuation and the acoustics when walking, while a greater thickness would degrade the punching resistance.

In this continuity, the density of the second damping layer in the form of a non-woven glass fiber sheet is between 90 and 150 kg/m³. A lower density would degrade the punching resistance, while a greater density would degrade the acoustic attenuation and the acoustics when walking. The use of glass fibers also provides a better acoustic and mechanical performance than conventional fibers, such as polyethylene fibers.

### BRIEF DESCRIPTION OF THE DRAWINGS

Other features and advantages of the invention will clearly emerge from the description of it which is made below, for information and in a totally non-limiting way, in reference to the accompanying figures, wherein:

FIG. 1 is a cross-sectional view of a first embodiment of a multi-layer structure according to the invention.

FIG. 2 is a cross-sectional view of a second embodiment of a multi-layer structure according to the invention, the second damping layer in contact with the floor being made of PVC foam.

FIG. 3 is a view similar to that of FIG. 2, the second damping layer in contact with the floor being presented in the form of a non-woven glass fiber sheet.

### DETAILED DESCRIPTION OF THE INVENTION

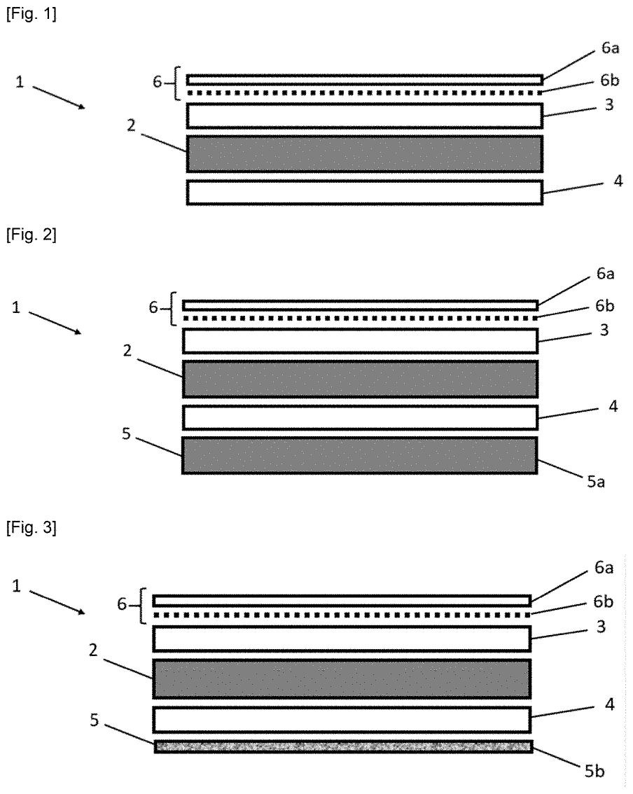

In reference to FIGS. 1, 2 and 3, the invention relates to a multi-layer structure (1), for example of the panel, tile or slat type, for the realization of a floor covering, for example, glued-down, or floating combined with the male/female coupling means complementarily present on the edges of the structure.

The invention aims, in particular, to provide such a structure for the realization of a floor covering having good acoustic insulation performance, by enabling the attenuation of the impact noise and sound when walking, measured for example according to standard NF EN ISO 717-2, while keeping a satisfactory punching resistance according to standard NF EN ISO 24343-1.

According to the invention, to achieve this performance, the multi-layer structure (1) has a first damping layer (2) positioned between two PVC-based rigid layers (3, 4), with optionally a second damping backing layer (5), i.e. intended to be in contact with the floor.

More specifically, the multi-layer structure (1) comprises a decorative layer (6), intended to form the surface layer of the floor covering, and is for example constituted of a transparent wear layer (6a), preferably made of non-expanded plasticized PVC, and a decorative film (6b). The decorative layer (6) can also be obtained from granules made from PVC then pressed, or also by plastisol coating, by flat-die extrusion or by calendering.

In an unknown way, the decorative film (6b) can be replaced by a layer for printing décor, printed on the lower face of the wear layer (6a), or on the upper face of a first rigid layer (3) to which said decorative layer (6) is bonded.

The wear layer (6a) ensures the mechanical and chemical resistance of the product and has a thickness, for example, of between 0.1 and 1 mm, preferably between 0.3 and 0.7 mm, for example 0.5 mm, and the decorative film (6b), positioned under the wear layer (6a) has a thickness of 0.1 mm, for example. The wear layer (6a) has a density, for example, of between 1200 and 2200 kg/m³ and/or a Young's modulus of between 100 and 500 MPa.

Thus, the multi-layer structure (1) according to the invention comprises, in this order, the decorative layer (6), a first rigid layer (3) made of PVC, a first damping layer (2) made of PVC, a second rigid layer (4) made of PVC. According to a variant, the multi-layer structure comprises a second damping layer (5) made of PVC foam (5a), see FIG. 2, or in the form of a non-woven glass fiber sheet (5b), see FIG. 3.

The first and second rigid layers (3, 4) each comprise an elasticity modulus of between 1.5 GPa and 12 GPa, measured according to standard ISO 178:2011.

The different layers (6, 3, 2, 4, 5) are bonded to one another, for example by coextrusion, lamination or gluing. Bonding layers such as polyurethane (PU) or “hotmelt” glues, can also be used to bond the layers to one another. The layers (6, 3, 2, 4) are preferably heat-bonded, in particular when the first damping layer (2) is a non-foam layer.

In the case where the second damping layer (5) is a non-woven layer, the assembly will be done by gluing, for example using a PU or “hotmelt” glue.

The first rigid layer (3) and/or the second rigid layer (4) has a density of between 1150 kg/m³ and 2500 kg/m³, preferably between 1600 kg/m³ and 2100 kg/m³.

Without moving away from the scope of the invention, the first rigid layer (3) and/or the second rigid layer (4) can each be constituted of two layers of different densities in the range of values specified above.

The first rigid layer (3) and/or the second rigid layer (4) preferably comprises a flex resistance of between 15 MPA and 30 MPa, preferably between 20 and 25 MPa, measured according to standard ISO 178:2011.

As an example, the first PVC foam damping layer (2) and/or the second PVC foam damping layer (5a) has between 50 and 60%, and preferably 55% of PVC, and between 35 and 40%, preferably 37% of plasticizers in total weight of the layer.

According to an example of a construction called example no. 1, the first PVC rigid layer (3) has a thickness of 3 mm and a density of 1926 kg/m³. The first PVC rigid layer (3) also has a flex resistance of 22.22 Mpa, measured according to standard ISO 178:2011, an elasticity modulus (deformation of 0.05 to 0.25%) of 7.77 GPa, measured according to standard ISO 178:2011, and a storage modulus of 9.37 GPa, measured according to a test method based on standard EN 29-052-1.

The first damping layer (2) is made of PVC foam having a thickness of 1 mm and a density of 450 kg/m³. The storage modulus of the first damping layer (2) is 0.458 MPa, measured according to the test method based on standard EN 29-052-1.

The second PVC rigid layer (4) has a thickness of 2 mm and has parameters which are identical to those of the first PVC rigid layer (3), in particular in terms of density, flex resistance, elasticity modulus and storage modulus.

In this example no. 1, the second damping layer (5) is presented in the form of a non-woven glass fiber sheet (5b) of a thickness of 0.8 mm and of a density of 121.75 kg/m³.

The non-woven glass fibers are bonded together by a binder, which is for example a phenolic resin which represents, for example, between 11 and 29% of the mass of the glass fiber sheet (5b), for example 18%.

The compression resistance of the non-woven glass fiber sheet (5b), to 10% deformation is:

greater than or equal to 1000 Pa, preferably greater than or equal to 3900 Pa for a 5×5 cm sample;

greater than or equal to 500 Pa, preferably greater than or equal to 1700 Pa, for a 10×10 cm sample;

greater than or equal to 500 Pa, preferably greater than or equal to 1600 Pa, for a 20×20 cm sample.

The compression resistance of the non-woven glass fiber sheet (5b), for a 0.5 mm deformation, is:

greater than or equal to 7000 Pa, preferably greater than or equal to 15000 Pa, for a 5×5 cm sample;

greater than or equal to 1000 Pa, preferably greater than or equal to 5000 Pa, for a 10×10 cm sample;

greater than or equal to 10200 Pa, preferably greater than or equal to 19100 Pa, for a 20×20 cm sample.

A lower compression resistance degrades the punching resistance of the multi-layer structure (1).

The compression resistance of the second damping layer (5) makes it possible to preserve a good acoustic insulation over time, while contributing to the traffic resistance of the assembly means (if they exist). The compression resistance is connected to the fiber surface mass, to a binder surface mass, to the nature and the resilience of the fibers. A person skilled in the art knows how to adapt these parameters to obtain the desired compression resistance values.

The compression resistance is measured according to standard CEN/TS 16354:2012 which itself makes reference to standard NF EN 826 of May 2013. This method corresponds to a compression measurement for a 0.5 mm deformation.

Tests carried out on the example no. 1 according to standard NF EN ISO 717-2 have made it possible to satisfactorily observe an acoustic attenuation of 19 dB, acoustics when walking of 75 dB, a 2.5-hour punching of 0.29 mm and a 24-hour punching of 0.22 mm.

Tests have also been carried out on an example no. 2 according to standard NF EN ISO 717-2.

According to this example no. 2, the nature of the layers is identical to that of example no. 1, except for:

the first PVC rigid layer (3) having a thickness of 2 mm instead of 3 mm;

the first PVC form damping layer (2) having a density of 300 kg/m³ instead of 450 kg/m³.

These tests have made it possible to satisfactorily observe an acoustic attenuation of 19.7 dB, acoustics when walking of 71 dB, a 2.5-hour punching of 0.38 mm and a 24-hour punching of 0.30 mm.

According to a second method for constructing the multi-layer structure (1) according to the invention, the second damping layer (5) is a PVC foam (5a).

Tests have also been carried out on an example no. 3, according to the second embodiment, and according to standard NF EN ISO 717-2.

According to this example no. 3, the nature of the layers is identical to that of example no. 1, except for:

the first PVC foam damping layer (2) having a density of 200 kg/m³ instead of 450 kg/m³;

the second damping layer (5) being a PVC form (5a) having a density of 450 kg/m³ and a thickness of 1 mm.

These tests have made it possible to satisfactorily observe an acoustic attenuation of 19 dB, acoustics when walking of 77 dB, a 2.5-hour punching of 0.32 mm and a 24-hour punching of 0.27 mm.

Tests have also been carried out on an example no. 4, according to the second embodiment, and according to standard NF EN ISO 717-2.

According to this example no. 4, the nature of the layers is identical to that of example no. 3, except for:

the first rigid layer (3) having a thickness of 2 mm instead of 3 mm;

the first PVC foam damping layer (2) having a density of 300 kg/m3 instead of 200 kg/m3.

These tests have made it possible to satisfactorily observe an acoustic attenuation of 17 dB, acoustics when walking of 72 dB, a 2.5-hour punching of 0.30 mm and a 24-hour punching of 0.24 mm.

As a summary of the examples tested of multi-layer structures:

### Example No. 1

Decorative layer (6): PVC wear layer (6a), thickness: 0.5 mm+printed decorative film (6b),

1^{st} rigid layer (3): PVC, thickness: 3 mm, density: 1926 kg/m³, flex resistance: 22.22 Mpa, flex modulus: 7.77 GPa, storage modulus: 9.37 GPa,

1^{st} damping layer (2): closed cell PVC foam, thickness: 1 mm, density: 450 kg/m³, storage modulus: 0.458 Mpa,

2^{nd} rigid layer (4): PVC, thickness: 2 mm, density: 1926 kg/m³, flex resistance: 22.22 Mpa, flex modulus: 7.77 GPa, storage modulus: 9.37 GPa,

2^{nd} damping layer (5): Non-woven glass fiber sheet (5b), thickness: 0.8 mm, density: 121.75 kg/m³, compression resistance to 10% deformation equal to 3900 Pa for a 5×5 cm sample.

### Example No. 2

Decorative layer (6): PVC wear layer (6a) thickness: 0.5 mm+printed decorative film (6b),

1st rigid layer (3): PVC, thickness: 2 mm, density: 1926 kg/m³, flex resistance: 22.22 Mpa, flex modulus: 7.77 GPa, storage modulus: 9.37 GPa,

1st damping layer (2): closed cell PVC foam, thickness: 1 mm, density: 300 kg/m³, storage modulus: 0.458 Mpa,

2^{nd} rigid layer (4): PVC, thickness: 2 mm, density: 1926 kg/m³, flex resistance: 22.22 Mpa, flex modulus: 7.77 GPa, storage modulus: 9.37 GPa,

2^{nd} damping layer (5): Non-woven glass fiber sheet (5b), thickness: 0.8 mm, density: 121.75 kg/m³, compression resistance to 10% deformation equal to 3900 Pa for a 5×5 cm sample.

### Example No. 3

Decorative layer (6): PVC wear layer (6a), thickness: 0.5 mm+printed decorative film (6b),

1^{st} rigid layer (3): PVC, thickness: 3 mm, density: 1926 kg/m³, flex resistance: 22.22 Mpa, flex modulus: 7.77 GPa, storage modulus: 9.37 GPa,

1^{st} damping layer (2): closed cell PVC foam, thickness: 1 mm, density: 200 kg/m³, storage modulus: 0.458 Mpa,

2^{nd} rigid layer (4): PVC, thickness: 2 mm, density: 1926 kg/m³, flex resistance: 22.22 Mpa, flex modulus: 7.77 GPa, storage modulus: 9.37 GPa,

2^{nd} damping layer (5): closed cell PVC foam (5a), thickness: 1 mm, density: 450 kg/m³, storage modulus: 0.458 Mpa.

### Example No. 4

Decorative layer (6): PVC wear layer (6a), thickness: 0.5 mm+printed decorative film (6b),

1^{st} rigid layer (3): PVC, thickness: 2 mm, density: 1926 kg/m³, flex resistance: 22.22 Mpa, flex modulus: 7.77 GPa, storage modulus: 9.37 GPa,

1^{st} damping layer (2): closed cell PVC foam, thickness: 1 mm, density: 300 kg/m³, storage modulus: 0.458 Mpa,

2^{nd} rigidity layer (4): PVC, thickness: 2 mm, density: 1926 kg/m³, flex resistance: 22.22 Mpa, flex modulus: 7.77 GPa, storage modulus: 9.37 GPa,

2^{nd} damping layer (5): closed cell PVC foam (5a), thickness: 1 mm, density: 450 kg/m³, storage modulus: 0.458 Mpa.

Examples 5 to 8 describe other possible variants according to the invention also tested according to standard NF EN ISO 717-2.

### Example No. 5

Decorative layer (6): PVC wear layer (6a), thickness: 0.5 mm+printed decorative film (6b),

1^{st} rigid layer (3): PVC, thickness: 2 mm, density: 1926 kg/m³, flex resistance: 22.22 Mpa, flex modulus: 7.77 GPa, storage modulus: 9.37 GPa,

1^{st} damping layer (2): Plasticized and expanded PVC calendered layer, thickness: 0.6 mm, Young's modulus 121 MPa, density: 1926 kg/m³,

2^{nd} rigid layer (4): PVC, thickness: 2 mm, density: 1926 kg/m³, flex resistance: 22.22 Mpa, flex modulus: 7.77 GPa, storage modulus: 9.37 GPa.

### Example No. 6

Decorative layer (6): PVC wear layer (6a), thickness 0.5 mm+printed decorative film (6b),

1^{st} rigid layer (3): PVC, thickness: 2 mm, density: 1926 kg/m³, flex resistance: 22.22 Mpa, flex modulus: 7.77 GPa, storage modulus: 9.37 GPa,

1^{st} damping layer (2): closed cell PVC foam, thickness: 1 mm, density: 300 kg/m³, storage modulus: 0.458 Mpa,

2^{nd} rigid layer (4): PVC, thickness: 2 mm, density: 1926 kg/m³, flex resistance: 22.22 Mpa, flex modulus: 7.77 GPa, storage modulus: 9.37 GPa.

### Example No. 7

Decorative layer (6): PVC wear layer (6a), thickness 0.5 mm+printed decorative film (6b),

1^{st} rigid layer (3): PVC, thickness: 2 mm, density: 1926 kg/m³, flex resistance: 22.22 Mpa, flex modulus: 7.77 GPa, storage modulus: 9.37 GPa,

1^{st} damping layer (2): closed cell PVC foam (5a), thickness: 1 mm, density: 450 kg/m³, storage modulus: 0.458 Mpa,

2^{nd} rigid layer (4): PVC, thickness: 2 mm, density: 1926 kg/m³, flex resistance: 22.22 Mpa, flex modulus: 7.77 GPa, storage modulus: 9.37 GPa,

2^{nd} damping layer (2): non-woven glass fiber sheet (5b), thickness 1 mm, compression resistance to 10% deformation equal to 3900 Pa for a 5×5 cm sample.

### Example No. 8

Decorative layer (6): PVC wear layer (6a), thickness 0.5 mm+printed decorative film (6b),

1^{st} rigid layer (3): PVC, thickness: 2 mm, density: 1926 kg/m³, flex resistance: 22.22 Mpa, flex modulus: 7.77 GPa, storage modulus: 9.37 GPa,

1^{st} damping layer (2): Plasticized and expanded PVC calendered layer, thickness: 0.6 mm, Young's modulus 121 MPa, density: 1926 kg/m³,

2^{nd} rigid layer (4): PVC, thickness: 2 mm, density: 1926 kg/m³, flex resistance: 22.22 MPa, flex modulus: 7.77 GPa, storage modulus: 9.37 GPa

2^{nd} damping layer (2): non-woven glass fiber sheet (5b), thickness: 1.3 mm, compression resistance to 10% deformation greater than or equal to 3900 Pa for a 5×5 cm sample.

The results from the test are compiled in the table below:

TABLE 1

| | | Acoustics | | |
|---|---|---|---|---|
| | Acoustic | when | 2.5-hour | 24-hour |
| | attenuation | walking | punching | punching |
| | (dB) | (dB) | (mm) | (mm) |
| Example | 19 | 75 | 0.29 | 0.22 |
| no. 1 | | | | |
| Example | 19.7 | 71 | 0.38 | 0.30 |
| no. 2 | | | | |
| Example | 19 | 77 | 0.32 | 0.27 |
| no. 3 | | | | |
| Example | 17 | 72 | 0.30 | 0.24 |
| no. 4 | | | | |
| Example | 6 | 80 | <0.40 | <0.30 |
| no. 5 | | | | |
| Example | 16 | 76 | <0.40 | <0.30 |
| no. 6 | | | | |
| Example | 17 | 75 | 0.28 | 0.23 |
| no. 7 | | | | |
| Example | 19 | 75 | 0.24 | 0.18 |
| no. 8 | | | | |

It results from the above that the invention does provide a multi-layer structure making it possible to have a good acoustic attenuation, as the acoustic attenuation values reach 19 dB according to standards NF S31-074-717-2 and NF EN ISO 717-2 and good acoustics when walking with values always less than 80, even 75 dB according to standard NF EN ISO 10140-3 and NF EN ISO 717-2. In addition, the 2.5-hour and 24-hour punching resistance according to standard NF EN ISO 24343-1 remains respectively less than 0.40 and 0.30, which is satisfactory.

What is claimed is:

1. A multi-layer structure of tile or slat type, for realization of a floor covering having acoustic insulation properties, the structure comprising, in order:
a decorative layer;
a first rigid layer made of PVC;
a first damping layer made of PVC; and
a second rigid layer made of PVC,
wherein each rigid layer comprises an elasticity modulus of between 1.5 GPa and 12 GPa, measured according to standard ISO 178:2011.

2. The multi-layer structure according to claim 1, wherein the first damping layer is a non-foam layer.

3. The multi-layer structure according to claim 1, wherein the first damping layer is a foam layer.

4. The multi-layer structure according to claim 2, wherein the first damping layer comprises a Young's modulus of between 25 MPa and 1.5 GPa.

5. The multi-layer structure according to claim 3, wherein the first damping layer comprises a storage modulus of between 0.1 MPa and 10 MPa.

6. The multi-layer structure according to claim 1, wherein the multi-layer structure comprises a thickness of between 4 and 8 mm, with the first rigid layer having a thickness of between 1 and 3.5 mm, and the second rigid layer having a thickness of between 1 and 3 mm.

7. The multi-layer structure according to claim 1, wherein the first rigid layer and/or the second rigid layer comprises a density of between 1150 kg/m³ and 2500 kg/m3.

8. The multi-layer structure according to claim 1, further comprising a second damping layer configured to contact with the floor, wherein the second damping layer comprises PVC foam or in the form of a non-woven glass fiber sheet.

9. The multi-layer structure according to claim 3, wherein the first damping layer comprises a density of between 150 and 600 kg/m³.

10. The multi-layer structure according to claim 8, wherein the second damping layer comprises a density of between 150 and 600 kg/m³.

11. The multi-layer structure according to claim 2, wherein the first damping layer comprises a thickness of between 0.5 and 1.5 mm.

12. The multi-layer structure according to claim 8, wherein the second damping layer comprises a thickness of between 0.5 and 1.5 mm.

13. The multi-layer structure according to claim 8, wherein the second damping layer in the form of a non-woven glass fiber sheet has a thickness of between 0.7 and 1.7 mm.

14. The multi-layer structure according to claim 4, wherein the first damping layer comprises a Young's modulus of between 50 and 500 MPa.

15. The multi-layer structure according to claim 7, wherein the first rigid layer and/or the second rigid layer comprises a density of between 1600 kg/m³ and 2100 kg/m³.

16. The multi-layer structure according to claim 9, wherein the first damping layer comprises a density of between 300 and 450 kg/m³.

17. The multi-layer structure according to claim 10, wherein the second damping layer comprises a density of between 300 and 450 kg/m³.

18. The multi-layer structure according to claim 11, wherein the first damping layer comprises a thickness of between 0.9 and 1.1 mm.

19. The multi-layer structure according to claim 12, wherein the second damping layer comprises a thickness of between 0.9 and 1.1 mm.

20. The multi-layer structure according to claim 13, wherein the second damping layer in the form of a non-woven glass fiber sheet has a thickness of between 1 and 1.5 mm.
